(19) United States
(12) Patent Application Publication
(10) Pub. No.: US 2013/0235216 A1
(43) Pub. Date: Sep. 12, 2013

(54) IMAGE CAPTURING DEVICE

(71) Applicant: ASUSTEK COMPUTER INC., Taipei (TW)

(72) Inventors: Hsin-Yi LEE, Taipei (TW); Shao-Hsing HUNG, Taipei (TW); Chun-Liang WU, Taipei (TW)

(73) Assignee: ASUSTeK COMPUTER INC., Taipei (TW)

(21) Appl. No.: 13/765,793

(22) Filed: Feb. 13, 2013

(30) Foreign Application Priority Data
Mar. 12, 2012 (TW) 201210063688.9

(51) Int. Cl. G06F 3/00

(52) U.S. Cl. CPC G06F 3/005
USPC 348/207.1

(57) ABSTRACT

An image capturing device includes an image capturing module and a base module. The image capturing module includes a sub base unit and an image capturing unit. The image capturing unit generates an image signal to the sub base unit. The base module receives the image signal from the sub base unit and transmits the image signal to an electronic device via wireless transmission.

### CROSS-REFERENCE TO RELATED APPLICATION

This application claims the priority benefit of China application serial No. 201210063688.9, filed on Mar. 12, 2012. The entirety of the above-mentioned patent application is hereby incorporated by reference herein and made a part of specification.

### BACKGROUND OF THE INVENTION

1. Field of the Invention

The disclosure relates to an electronic device and, more particularly, to a portable electronic device.

2. Description of the Related Art

Nowadays, electronic devices, such as a notebook computer, are necessary in daily life. A notebook computer usually includes an image capturing device, such as a video camera, and a desktop computer and a television also have an image capturing function.

FIG. 1 is a schematic diagram showing a conventional notebook computer 1. The notebook computer 1 includes a photographic lens 11 fixed at an upper casing 12. However, since the photographic lens 11 is fixed at the fixed position, when the user uses the photographic lens 11 to take photos or video recording, objects should be disposed in front of the photographic lens 11, or the user moves the notebook computer 1 to make the photographic lens 11 at a proper position to capture the objects. Thus it is inconvenient for users to use the photographic device. The desktop computer or the television uses an external and wired image capturing device, which is also troublesome.

### BRIEF SUMMARY OF THE INVENTION

An image capturing device includes an image capturing module and a base module. The image capturing module includes a sub base unit and an image capturing unit which generates an image signal to the sub base unit. The base module receives the image signal from the sub base unit, and transmits the image signal to an electronic device via wireless transmission.

These and other features, aspects and advantages of the present disclosure will become better understood with regard to the following description, appended claims, and accompanying drawings.

### BRIEF DESCRIPTION OF THE DRAWINGS

FIG. 1 is a schematic diagram showing a conventional notebook computer; and

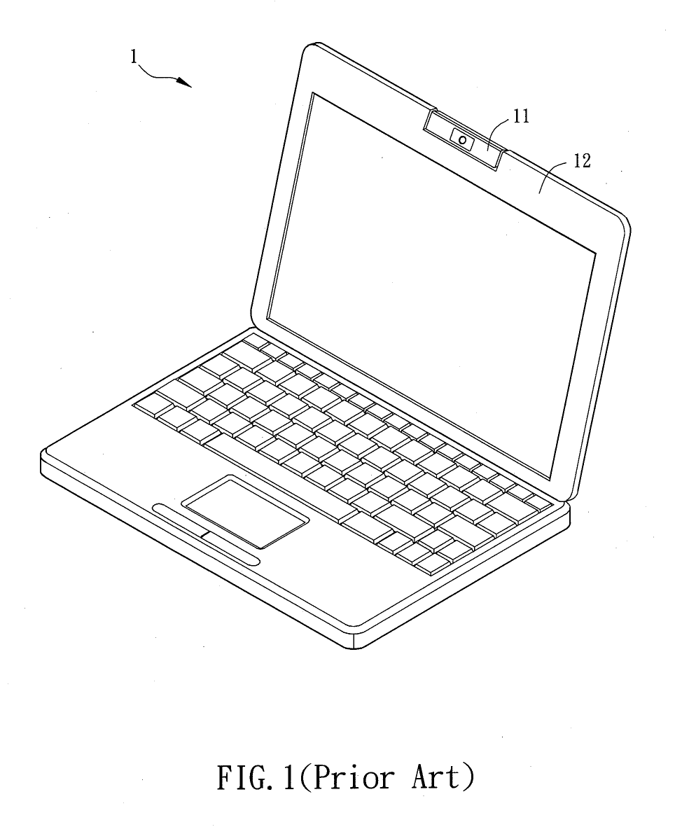

FIG. 2 is a schematic diagram showing an image capturing device in an embodiment.

### DETAILED DESCRIPTION OF THE EMBODIMENTS

A portable electronic device is illustrated with relating figures, and the same symbols denote the same components.

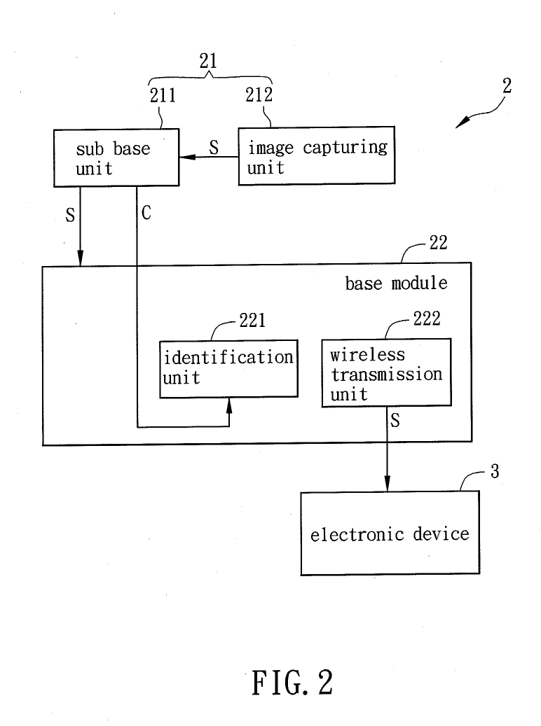

FIG. 2 is a schematic diagram showing an image capturing device 2 in an embodiment. The image capturing device 2 includes an image capturing module 21 and a base module 22. The image capturing device 2 may include one or more image capturing modules 21, and the number of the image capturing modules 21 is not limited. The image capturing module 21 may be a video recording module or a camera module. The image capturing module 21 and the base module 22 are separable. The image capturing module 21 may be provided power by a universal serial bus (USB) connected to the base module 22 (for example, when the image capturing module 21 is placed at the base module 22), or by a USB connected to a socket unit which is further connected to a socket (for example, when the image capturing module 21 is separate from the base module 22). As mention above, it's not limited herein.

Since the image capturing module 21 and the base module 22 are separable. In the embodiment, the image capturing device 2 not only can be used as a peripheral device of an electronic device 3, but also can be used separable from the base module 22. For example, the image capturing module 21 may be used as a remote monitoring lens, which avoids the using limits and improves the convenience.

The image capturing module 21 includes a sub base unit 211 and an image capturing unit 212. The image capturing unit 212 may be a video recording module or a camera module. The image capturing unit 212 generates an image signal S and transmits it to the sub base unit 211. The image capturing unit 212 transmits the image signal S to the sub base unit 211 via wired or wireless transmission. The sub base unit 211 transmits the image signal S to the base module 22 via wired or wireless transmission.

Thus, the image capturing module 21 further broadens using range of the image capturing device 2 by separating the image capturing unit 212 and the sub base unit 211.

The base module 22 receives the image signal S which is transmitted to an electronic device 3 via the wireless transmission. The wireless transmission may be wireless fidelity (Wi-Fi) network transmission. The electronic device 3 may be a desktop computer, a notebook computer, a tablet computer, a display, a portable communication device or a personal digital assistant (PDA) with a wireless transmission function.

Moreover, the base module 22 includes an identification unit 221 and a wireless transmission unit 222.

Thus, the image capturing module 21 can transmit an identification signal C to the identification unit 221. The base module 22 determines whether the image capturing module 21 is included in the image capturing device 2, so as to avoid receiving wrong signals or an image signal from other image capturing modules. In other word, the identification unit 221 of the base module 22 may achieve the identification process by transmitting the identification signal to the electronic device 3.

The base module 22 transmits the image signal S to the electronic device 3 directly via the wireless transmission unit 222 (such as Wi-Fi) instead of a router or a wireless network bridge, which further improves the convenience of using the image capturing device 2.

The image capturing device also includes a fixing module (not shown). The fixing module may be a locking module, a clamping module or a sliding and fixing module, and the base module is fixed at the electronic device by the fixing module. The image capturing device may not be fixed at the electronic device and it also can be placed on a surface, which is not limited herein.

In summary, the image capturing device includes a base module and an image capturing module, and the image capturing module and the base module are separable. The base module transmits an image signal to an electronic device via the wireless transmission. Consequently, the user can use the image capturing module and the base module independently to reduce the using range limitation and improve the convenience of the image capturing module. If multiple image capturing modules are used, the design of wireless transmission can also avoid the wire in a knot. Furthermore, if the base module includes a wireless transmission unit, the base module can directly transmit the image signal to the electronic device instead of a router or a wireless network bridge, which further improves the convenience of the image capturing device.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An image capturing device, comprising:
an image capturing module including a sub base unit and an image capturing unit which generates an image signal to the sub base unit; and
a base module receiving the image signal from the sub base unit and transmitting the image signal to an electronic device via wireless transmission.

2. The image capturing device according to claim 1, wherein the image capturing module and the base module are separable.

3. The image capturing device according to claim 1, wherein the image capturing unit transmits the image signal to the sub base unit via wire transmission or the wireless transmission.

4. The image capturing device according to claim 1, wherein the sub base unit transmits the image signal to the base module via wire transmission or the wireless transmission.

5. The image capturing device according to claim 1, wherein the base module includes an identification unit, and the image capturing module further transmits an identification signal to the identification unit.

6. The image capturing device according to claim 1, wherein the base module includes a wireless transmission unit, and the base module transmits the image signal to the electronic device via the wireless transmission unit.

7. The image capturing device according to claim 1, wherein the image capturing device further includes:
a fixing module using for fixing the base module at the electronic device.

8. The image capturing device according to claim 1, wherein the sub base unit and the image capturing unit are separable.
